(19) United States
(12) Patent Application Publication
(10) Pub. No.: US 2014/0350749 A1
(43) Pub. Date: Nov. 27, 2014

(54) VEHICLE MANAGEMENT SYSTEM AND METHOD

(71) Applicant: HYUNDAI MOTOR COMPANY, Seoul (KR)

(72) Inventor: Jong Duck Kwak, Gwacheon (KR)

(73) Assignee: HYUNDAI MOTOR COMPANY, Seoul (KR)

(21) Appl. No.: 13/898,811

(22) Filed: May 21, 2013

(51) Int. Cl. B60R 16/023

(52) U.S. Cl. CPC B60R 16/0231
USPC 701/2

(57) ABSTRACT

A vehicle management system and method that include part control units that execute operations of vehicle parts based on sensed information of a vehicle. A control server receives vehicle and driver information. A main controller is disposed within the vehicle and communicates with the part control units, the control server, and an occupant terminal, to mediate authentication of the occupant terminal under control of the control server. The main controller receives information from the part control units and provides the information to the occupant terminal. Additionally, the main controller receives a request from the occupant terminal and executes the operation of the part control units. Furthermore, the main controller provides vehicle states and the request from the occupant terminal, and allows a program related to execution of operation of a part control unit for a new electric/electronic part to be installed when the new electric/electronic part is installed.

### BACKGROUND OF THE INVENTION

1. Field of the Invention

The present invention relates to a vehicle management system that controls and manages information between a vehicle and various types of electric/electronic parts attachable to the vehicle in an integrated manner.

2. Description of the Related Art

As Information Technology (IT) that is introduced to sensors and electric/electronic parts (e.g., a navigation device, a mobile communication terminal, an audio system, etc.) in various systems, such as for driving a vehicle and the control of a vehicle body, advances, systematic and organic connections are required between the sensors and the electric/electronic parts. In particular, various electric/electronic parts, such as a navigation device, a smart phone, and a tablet Personal Computer (PC), mounted in a space occupied by a driver and a passenger, are rapidly varied at high speed, and thus, an inter-vehicle environment suitable for the varying electric/electronic parts is required, and the implementation of new functions based on connectivity with a vehicle is required.

For this function, an integrated and adaptable ecosystem may be considered in which a main controller is disposed within a vehicle, and information generated by the vehicle is provided to the exterior of the vehicle or in which an external request is accommodated and transferred to the interior of the vehicle.

Further, when interface standards are developed and managed and an authentication procedure is provided to allow electric/electronic devices (e.g., a navigation device, an audio system, a mobile communication terminal, etc.) manufactured by a vehicle manufacturer and a third party to participate in such an ecosystem, and when the quality of the corresponding ecosystem is managed, a more adaptable consumer-correspondence system may be constructed.

In the past, when new parts were mounted within a vehicle in conformity with such a concept, it was difficult to merge the new parts into an existing vehicle control system, and it was also difficult to provide a variety of services due to insufficiency of communication with an occupant terminal. A conventional vehicle service using telematics merely enables information about designated parts to be transferred to an external server, allows the server to process the information and transfer the processed information back to the vehicle, and allows the transferred information to be displayed within the vehicle. As a result, there is inconvenience in mounting new parts and there is a lack of positive communication with an occupant, as described above.

The foregoing is intended merely to aid in the better understanding of the background of the present invention, and is not intended to mean that the present invention falls within the purview of the related art that is already known to those skilled in the art.

### SUMMARY

Accordingly, the present invention discloses a vehicle management system, which provides an ecosystem adaptable to environmental variations through a vehicle information gateway (e.g., Information Control Unit: ICU), an interface that connects the interior and exterior of a vehicle based on the ICU, and an authentication procedure, thus providing adaptability and advantages to a service provider and a driver.

The present invention provides a vehicle management system that includes a plurality of part control units configured to execute operations of vehicle parts based on sensed information of a vehicle; a control server provided with information about the corresponding vehicle and information about a driver; and a main controller disposed within the vehicle, and configured to communicate with the part control units, the control server, and an occupant terminal, to mediate authentication of the occupant terminal executed by the control server, to receive information from the part control units and provide the received information to the occupant terminal, to receive a request from the occupant terminal and operate the part control units, to provide vehicle states and the request from the occupant terminal to the control server, and to allow a program related to operation of a part control unit for a new electric/electronic part to be installed when the new electric/electronic part is installed within the vehicle.

The vehicle management system may further include a vehicle communication module that allows the main controller and the control server to communicate with each other over a mobile communication network for mobile phones or a wireless Internet. In addition, the control server may include a control program that executes the operation of the part control units of the vehicle, the control program being provided to the occupant terminal. The main controller may allow a program required to execute part control units for electric/electronic parts of the vehicle to be updated by the control server.

In accordance with the vehicle management system having the above configuration, it may be possible to construct main controller-centered hardware and software ecosystems within the vehicle, to standardize and normalize surrounding interfaces for connecting the interior and exterior of the vehicle, and to adapt with all types of vehicles, thus increasing development efficiency and ensuring price competitiveness.

Further, it may be possible to replace ecosystems of the corresponding parts depending on consumer needs and variations in market environments, part manufacturers may actively participate in the ecosystems, and the range of selection of consumers may expand based on such replacement and participation.

### BRIEF DESCRIPTION OF THE DRAWINGS

The above and other objects, features and advantages of the present invention will be more clearly understood from the following detailed description taken in conjunction with the accompanying drawing, in which:

FIG. 1 is an exemplary diagram showing the configuration of a vehicle management system according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, an exemplary embodiment of a vehicle management system according to the present invention will be described in detail with reference to the accompanying drawing.

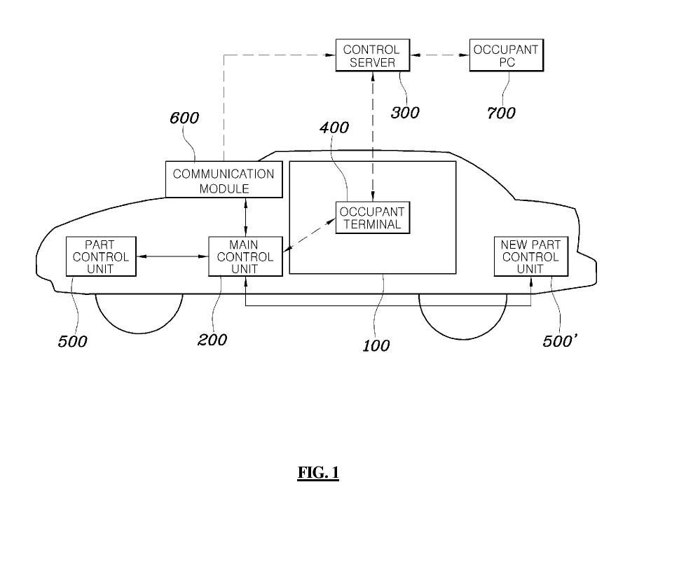

FIG. 1 is an exemplary diagram showing the configuration of a vehicle management system according to an exemplary embodiment of the present invention. A vehicle management system according to the present invention may include a plurality of part control units 500, an external control server 300, and a main controller 200. The part control units 500 may execute the operations of parts of a vehicle based on sensed information of the vehicle. The control server 300 may be installed outside of the vehicle and may receive information about the corresponding vehicle and a driver. The main controller 200 may be mounted within the vehicle and may be configured to communicate with the part control units 500, the control server 300, and an occupant terminal 400. The main controller 200 may be configured to mediate the authentication of the occupant terminal 400 under the control of the control server 300, to receive information from the part control units 500 and provide the received information to the occupant terminal 400, to receive a request from the occupant terminal 400 and execute the operation of the part control units 500, to provide vehicle states and the request from the occupant terminal 400 to the control server 300, and to allow a program related to the execution of the operation of a part control unit 500′ for a new electric/electronic part to be installed when the new electric/electronic part is installed within the vehicle.

In the vehicle of the present invention, a terminal, such as the mobile phone or the Personal

Computer (PC) of an occupant, may be disposed within a vehicle interior space 100. The plurality of part control units 500 for various types of parts, a communication module 600, and the main controller 200 may be disposed within the vehicle main controller. In addition, the control server 300 and the external PC 700 of the occupant may be disposed outside the vehicle.

From the standpoint of this environment, the control server 300 may be configured to receive the corresponding vehicle information and driver information, and may be configured to update the vehicle information. Further, the control server 300 may be configured to provide or update such vehicle information by communicating with the occupant PC 700. Additionally, the control server 300 may receive the driver information and may be configured to provide authentication information required for the procedure of authentication between the occupant terminal 400 and the main controller 200, to the main controller 200.

The main controller 200 may be configured to communicate with the part control units 500, the control server 300, and the occupant terminal 400. The main controller 200 may be configured to communicate with the part control units 500 of the vehicle via In-vehicle Network (control area network CAN, media orientated systems transport MOST, local interconnect network LIN, Ethernet, etc.) communication to exchange information. Further, the main controller 200 may be installed in a standardized space within the vehicle and may be connected to the occupant terminal 400 in a wired manner, or may be configured to communicate with the occupant terminal 400 using communication technology, such as WiFi or Bluetooth. Furthermore, the main controller 200 may be configured to communicate with the external control server 300 using the vehicle communication module 600 that enables communication over a mobile communication network for mobile phones or the wireless Internet.

In addition, the main controller 200 may be configured to mediate the authentication of the occupant terminal 400 under the control of the control server 300. Therefore, the main controller 200 may not damage the safety of the vehicle due to an independent operation or an unauthorized operation. Further, the main controller may be configured to prepare for the leakage of information about security or personal information. The main controller may be configured to receive information from the part control units 500, provide the received information to the occupant terminal 400, receive the request of the occupant terminal 400, and execute the operation of the part control units 500.

Furthermore, the main controller may be configured to receive various types of control information from the part control units 500 and provide the control information to the occupant terminal 400 to display the control information. For this operation, in the occupant terminal 400, a specific program may be installed. In particular, a basic program may be provided by the main controller 200 and an application program may be downloaded from the control server 300 that may be updated in real time.

Further, the main controller 200 may be configured to receive a request from the occupant terminal 400 and may execute the operation of the part control units 500. This operation may be performed when a specific program is installed in the occupant terminal 400. Even in this case, a basic program may be provided by the main controller 200, and an application program may be downloaded from the control server 300 that may be updated in real time.

In other words, the occupant terminal 400 may be implemented as a terminal mounted within the vehicle, such as a built-in navigation device or audio system, or a typical mobile phone or tablet PC used by a consumer while carrying the mobile phone or the tablet PC. This mobile phone or table PC may be connected in a wired or wireless manner and a specific program may be installed in such a terminal, and thus, the terminal may be configured to indirectly communicate with the part control units 500 of the vehicle via the main controller 200 while communicating with the main controller 200.

Further, when a new electric/electronic part is installed within the vehicle, the main controller 200 may be configured to enable a program related to the execution of an operation of a part control unit 500′ for the new electric/electronic part to be installed therein. In other words, when a part is purchased from the aftermarket to be mounted within the vehicle and use a newly upgraded part, it was difficult to link a standard or a controller for the part to the vehicle in the past, and thus it was difficult to satisfy the desires of consumers.

However, even in this case, the main controller 200 may be configured to accommodate a new part through a communication module having predetermined standards and may perform communication and utilize the new part. For this functionality, a program to be newly applied may be obtained from the control server 300. When the configuration is implemented in this way, the control server 300 may be configured to manage the control program of the corresponding new part control unit 500′, thus may be configured to maintain the safety or security of the vehicle.

Further, when the configuration is implemented in this way, the consumer may purchase and mount a desired part, and the main controller may be configured to download and apply a control program suitable for the part via the control server, and thus, the range of the aftermarket may expand and the satisfaction of consumers may be improved.

Meanwhile, the vehicle management system may further include the vehicle communication module 600 that allows the main controller 200 and the control server 300 to communicate over a mobile communication network for mobile phones or the wireless Internet. In the control server 300, a control program may be configured to execute the operation of the part control units 500 of the vehicle and may be provided to the occupant terminal 400. Furthermore, the main controller program that execute the operation of the part control units 500 for vehicle electric/electronic parts may be updated by the control server 300.

The above configuration has been described in the above description, and thus a detailed description thereof will be omitted here.

Meanwhile, in accordance with the vehicle management system having the above configuration, it may be possible to construct main controller-centered hardware and software ecosystems in the vehicle, to standardize and normalize surrounding interfaces that connect the interior and exterior of the vehicle, and to adjust with all types of vehicles, thus increasing development efficiency and ensuring price competitiveness.

Further, it may be possible to replace ecosystems the corresponding parts depending on consumer needs and variations in market environments, part manufacturers may actively participate in the ecosystems, and the range of selection of consumers may expand based on such replacement and participation.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A vehicle management system comprising:
a plurality of part control units configured to execute operations of vehicle parts based on sensed information of a vehicle;
a control server configured to receive information about the corresponding vehicle and information about a driver; and
a main controller disposed within the vehicle, and configured to:
communicate with the part control units, the control server, and an occupant terminal;
mediate authentication of the occupant terminal under control of the control server;
receive information from the part control units and provide the received information to the occupant terminal;
receive a request from the occupant terminal and execute the operation of the part control units; and
provide vehicle states and the request from the occupant terminal to the control server.

2. The vehicle management system of claim 1, further comprising:
a vehicle communication module that allows the main controller and the control server to communicate over a mobile communication network for mobile phones or a wireless Internet.

3. The vehicle management system of claim 1, wherein the control server includes a control program that executes the operation of the part control units of the vehicle, wherein the control program is provided to the occupant terminal.

4. The vehicle management system of claim 1, wherein the main controller updates a program required to execute operation of the part control units for electric/electronic parts of the vehicle via the control server.

5. A vehicle management method, comprising:
communicating with the part control units, the control server, and an occupant terminal;
mediating authentication of the occupant terminal under control of the control server;
receiving information from the part control units and provide the received information to the occupant terminal;
receiving a request from the occupant terminal and execute the operation of the part control units; and
providing vehicle states and the request from the occupant terminal to the control server.

6. The vehicle management system of claim 1, further comprising:
communicating with the control server over a mobile communication network for mobiles phones or a wireless Internet.

7. The vehicle management method of claim 5, wherein the control server includes a control program that executes the operation of the part control units of the vehicle, wherein the control program is provided to the occupant terminal.

8. The vehicle management method of claim 5, further comprising:
updating a program required to execute operation of the part control units for electric/electronic parts of the vehicle via the control server.

9. A non-transitory computer readable medium containing program instructions executed by a controller, the computer readable medium comprising:
program instructions that communicate with a plurality of part control units, a control server, and an occupant terminal;
program instructions that mediate authentication of the occupant terminal under control of the control server;
program instructions that receive information from the part control units and provide the received information to the occupant terminal;
program instructions that receive a request from the occupant terminal and execute the operation of the part control units; and
program instructions that provide vehicle states and the request from the occupant terminal to the control server.

10. The non-transitory computer readable medium of claim 9, wherein the program instructions communicate with the control server over a mobile communication network for mobiles phones or a wireless Internet.

11. The non-transitory computer readable medium of claim 9, wherein the control server includes a control program that executes the operation of the part control units of the vehicle, wherein the control program is provided to the occupant terminal.

12. The non-transitory computer readable medium of claim 9, further comprising:
program instructions that update to execute operation of the part control units for electric/electronic parts of the vehicle via the control server.
